(19) United States
(12) Patent Application Publication
(10) Pub. No.: US 2003/0157894 A1
(43) Pub. Date: Aug. 21, 2003

(54) Apparatus for testing isolation status in outdoor RF repeater and method thereof

(76) Inventors: Gyu-Duk Han, Seoul (KR); Hai-Yong Lee, Sungnam-city (KR)

Correspondence Address: RADER FISHMAN & GRAUER PLLC, LION BUILDING, 1233 20TH STREET N.W., SUITE 501, WASHINGTON, DC, 20036, US

(21) Appl. No.: 10/105,405

(22) Filed: Mar. 26, 2002

(30) Foreign Application Priority Data
Feb. 15, 2002 (KR) KR2002-8125

(51) Int. Cl. H04B 17/00

(52) U.S. Cl. 455/67.1; 455/423

(57) ABSTRACT

Disclosed is an apparatus and method for testing an isolation status in an RF repeater that is installed to provide a service to a shadow area. The method for testing the isolation status in the RF repeater comprises the steps of: detecting a first uplink output level by shutting off a downlink of the RF repeater and setting a maximum gain value of an uplink from a mobile terminal at a central processing unit; setting a gain value of the uplink to become higher than the maximum gain value and detecting a second uplink output level form the mobile terminal; displaying a state that an isolation of the RF repeater is ensured to the outside when a difference value between the second uplink output level and the first uplink output level is smaller than a preset difference value (a maximum value allowing the isolation to be ensured) stored in a central processing unit of an existing RF repeater; and displaying a state that an isolation of the RF repeater is not ensured to the outside when the difference value is larger than the stored difference value. As a consequence, the isolation status in the RF repeater installed in the shadow area can be easily tested without any help of special equipments.

### BACKGROUND OF THE INVENTION

1. Field of the Invention

The present invention relates to a mobile communication system, and more particularly, to an apparatus and method for testing an isolation status in an RF repeater, which can test an isolation status in an RF repeater employed for a service in a shadow area.

2. Background of the Related Art

In general, an RF repeater is used in areas, such as a shielded space and a small-blocked shadow area, e.g., an underground shopping mall, a tunnel, an underground parking lot, etc. where a base station is difficult to be installed or a relay vehicle is difficult to be always operated. The RF repeater enables a service including a mobile phone service, etc. in a blind zone in a manner that a weak signal to be relayed among existing signals in the shielded space or the shadow area is extracted and amplified to a low noise, re-amplified to a high output, and reradiated through an antenna.

FIG. 1 is a view illustrating a construction of a conventional RF repeater and peripheral devices.

Referring to FIG. 1, the RF repeater is interposed between a base station and a mobile terminal, and serves to downlink a radio signal received from the base station to the mobile terminal and uplink a radio signal from a user to the base station, so as to remove a blind zone that might be generated due to an environment where the base station is installed and a position where the terminal is located.

In the RF repeater, it is very important that an isolation between a Tx antenna and an Rx antenna is ensured. Accordingly, upon the construction, the isolation status should be most considered. In particular, since a code division multiple access(CDMA) repeater utilizes the same frequency both in a downlink antenna and an uplink antenna, a distance and a direction between the antennas should be well selected in order to ensure the isolation.

If the repeater is installed in a state that a sufficient isolation is not ensured, the repeater causes a micro oscillation and sends an unnecessary RF signal to the base station, resulting in deterioration in communication quality. Further, when the RF repeater causes an incomplete oscillation until a shutdown level, it produces a baleful effect on the base station.

Therefore, the conventional RF repeater and the peripheral devices start the micro oscillation only when a gain of the RF repeater is sufficiently increased to over an isolation status value since any output is not detected in the uplink when the downlink is shut off. At this time, since a value detected in an uplink output terminal is represented as an oscillation output by the isolation, a method for testing the isolation status by using the value has been adopted.

Here, when the RF repeater is installed on the ground, even though a downlink pass of the repeater is shut off, there is always a possibility that a signal exists in an uplink band. This is because it is affected by an output of an wireless apparatus operated in the same band as used in the ground.

In consequence, if the method for testing the isolation status in the conventional indoor-type RF repeater is applied to an outdoor type, when a communication occurs in a mobile terminal in the vicinity while the isolation status is checked, it is highly possible that a level sensing part for sensing an uplink level mistakes a pertinent level for an output value due to an oscillation although the sufficient isolation of the RF repeater is ensured.

### SUMMARY OF THE INVENTION

Accordingly, the present invention is directed to an apparatus for testing an isolation status in an outdoor RF repeater that substantially obviates one or more problems due to limitations and disadvantages of the related art.

An object of the present invention is to provide an apparatus for testing an isolation status in an outdoor RF repeater that can test an isolation status in an RF repeater without help of special measuring equipments.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for testing an isolation status in an outdoor RF repeater includes a downlink RF receiving part for transmitting/receiving a downlink RF signal from a base station, an uplink RF receiving part for transmitting/receiving an uplink RF signal from a mobile terminal, an output level sensing part for sensing an uplink signal of the uplink RF receiving part, a central processing unit for setting a maximum gain of an uplink detected from the RF output level sensing part, a displaying part for displaying an oscillation status according to the uplink signal by being connected to an output terminal of the central processing unit, and an amplifier for amplifying an RF signal by being connected to the output terminal of the central processing unit and the downlink RF receiving part.

A method for testing the isolation status in the RF repeater according to the present invention comprises the steps of: shutting off a downlink of the repeater and setting a maximum gain value of an uplink from the mobile terminal at the central processing unit; detecting a first uplink output level from the mobile terminal such that a gain value of the detected uplink is set to become higher than the maximum gain value, and detecting a second uplink output level from the mobile terminal; displaying a state that an isolation of the RF repeater is ensured to the outside when a difference value between the second uplink output level and the first uplink output level is smaller than a preset difference value (a maximum value capable of ensuring the isolation) stored in a central processing unit of an existing RF repeater; and displaying a state that an isolation of the RF repeater is not ensured to the outside when the difference value is greater than the stored difference value.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a layout view of a conventional RF repeater and peripheral devices;

FIG. 2 illustrates a circuit diagram of an apparatus for testing an isolation-status in an RF repeater according to the present invention; and

FIG. 3 illustrates a flow chart of a method for testing the isolation status in the RF repeater according to the present invention.

### DETAILED DESCRIPTION OF THE PREFERRED EMBODIMENT

Reference will now be made in detail to the preferred embodiments of the present invention, examples of which are illustrated in the accompanying drawings.

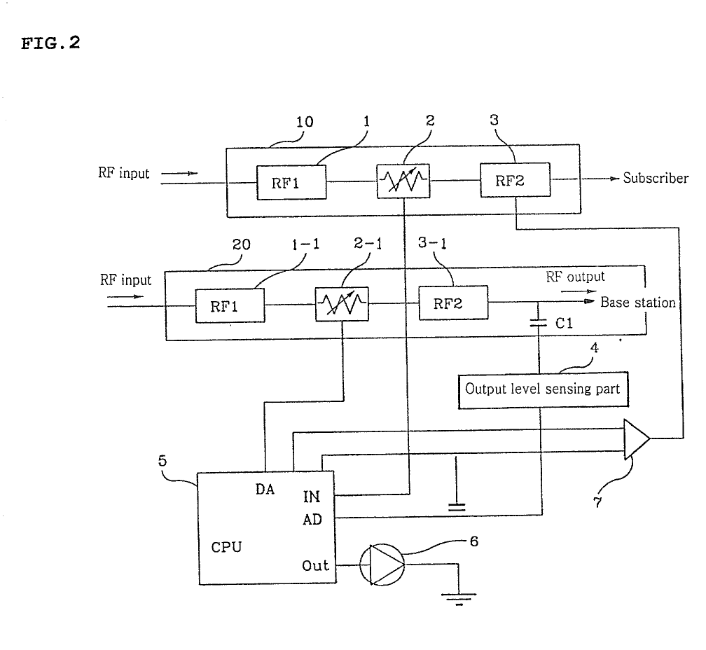

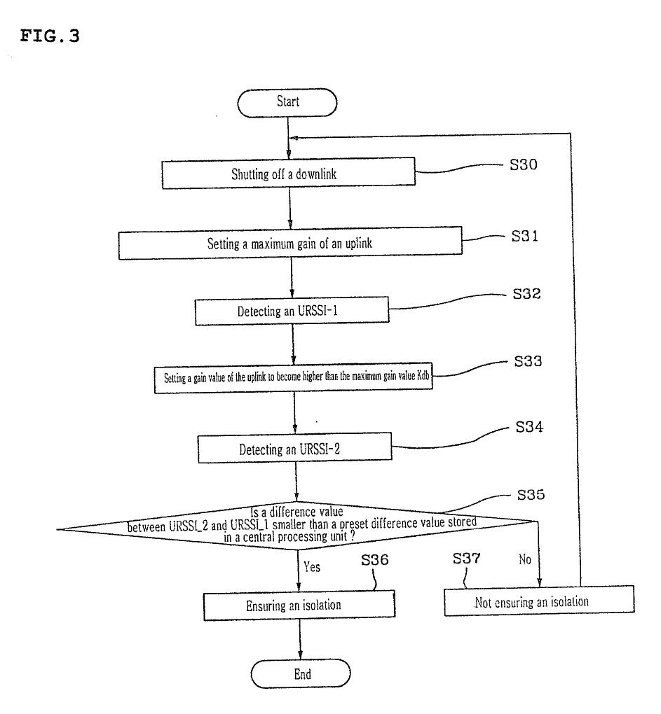

FIG. 2 illustrates a circuit diagram of an apparatus for testing an isolation status in an RF repeater according to the present invention, and FIG. 3 illustrates a flow chart of the apparatus for testing the isolation status in the RF repeater according to the present invention.

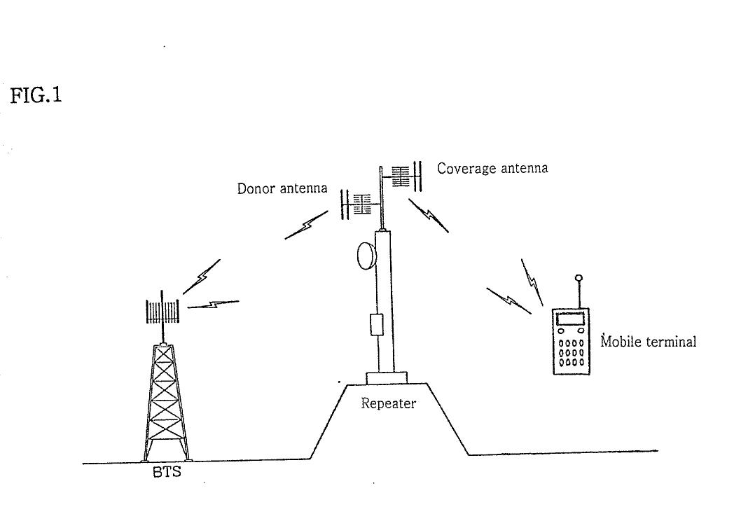

Referring to FIG. 2, the apparatus for testing the isolation status in the RF repeater according to the present invention includes a downlink RF receiving part 10 for transmitting/receiving a downlink RF signal from a base station(see FIG. 1), an uplink RF receiving part 20 for transmitting/receiving an uplink RF signal from a mobile terminal(see FIG. 1), an output level sensing part 4 for sensing an uplink signal of the uplink RF receiving part 20, a central processing unit for setting a maximum gain of an uplink detected from the output level sensing part 4, a displaying part 6 for displaying an oscillation status according to the uplink signal by being connected to an output terminal of the central processing unit 5, and an amplifier 7 for amplifying an RF signal by being connected to the output terminal of the central processing unit 5 and the downlink RF receiving part 10.

The downlink and uplink RF receiving parts 10 and 20 respectively include a plurality of first and second RF receiving parts 1 and 3, and 1-1 and 3-1 for transmitting/receiving up/downlink RF signals, and automatic level setting parts 2 and 2-1 for setting up/down signal levels by being connected between the first and second RF receiving parts 1 and 3, and 1-1 and 3-1. A coupling condenser C1 is connected between an output terminal of the second RF receiving part 3-1 and the output level sensing part 4.

Operation of the apparatus for testing the isolation status in the RF repeater constructed as above will be explained with reference to the flow chart illustrated in FIG. 3.

First, a downlink of the RF repeater that is to be installed becomes off and a maximum gain value Kdb of the uplink of the mobile communication terminal is set at S30. At this time, the downlink RF receiving part 10 is in an off state.

Then, the output level detecting part 4 detects a first-uplink output level URSSI_1 from the mobile terminal at S32, sets a gain value of the detected uplink to become higher than the maximum gain value Kdb at S33, and detects a second uplink output level URSSI_2 from the mobile terminal at S34.

When a difference value between the second uplink output level URSSI_2 and the first uplink output level URSSI_1 is smaller than a preset difference value(a maximum value capable of ensuring the isolation) stored in a central processing unit of an existing RF repeater, a state that the isolation of the RF repeater is ensured is displayed to the outside at S35 and S36.

When the difference value is greater than the maximum gain value of the uplink, a state that the isolation of the RF repeater is not ensured is displayed to the outside at S37. The above steps from S30 to S35 are repeated from the beginning.

Here, when the isolation of the RF repeater is not ensured, a light emitting diode 6 is turned on, whereas when the isolation of the RF repeater is ensured, the light emitting diode 6 is turned on and off. When the light emitting diode 6 is turned on, the above checking steps from S30 to S35 are repeated.

Finally, after installation of the RF repeater is completed, when an end key is inputted, an interrupt is caused in the central processing unit 5 and an operation is performed in a normal mode.

As stated above, the apparatus and method for testing the isolation status in the RF repeater according to the present invention has an advantage of reducing a cost by finding an optimal direction of the base station and easily installing the repeater as well as checking the isolation status in the repeater without any special equipments.

In the apparatus and method for testing the isolation status in the RF repeater according to the present invention, the maximum gain value may vary according to the detected value of the uplink, and the position where the RF repeater is installed is expected to vary according to the set value. Accordingly, The description of the present invention is intended to be illustrative, and not to limit the scope of the claims. Many alternatives, modifications, and variations will be apparent to those skilled in the art.

What is claimed is:

1. An apparatus for testing an isolation status in an RF repeater, the apparatus comprising:
a downlink RF receiving part for transmitting/receiving a downlink RF signal from a base station;
an uplink RF receiving part for transmitting/receiving an uplink RF signal from a mobile terminal;
an output level sensing part for sensing an uplink signal of the uplink RF receiving part;
a central processing unit for setting a maximum gain of an uplink detected from the output level sensing part;
a displaying part for displaying an oscillation status in accordance with the uplink signal by being connected to an output terminal of the central processing unit; and
an amplifier for amplifying an RF signal by being connected to the output terminal of the central processing unit and the downlink RF receiving part.

2. A method for testing an isolation status in an RF repeater, the method comprising the steps of:
shutting off a downlink of an RF repeater and setting a maximum gain value of an uplink from a mobile terminal at a central processing unit;
detecting a first uplink output level from the mobile terminal to set a gain value of the detected uplink to become higher than the maximum gain value, and detecting a second uplink output level from the mobile terminal;
displaying a state that an isolation of the RF repeater is ensured to the outside when a difference value between the second uplink output level and the first uplink output level is smaller than a preset difference value, which is a maximum value capable of ensuring the isolation, stored in a central processing unit of an existing RF repeater; and
displaying a state that an isolation of the RF repeater is not ensured to the outside when the difference value is greater than the stored difference value.
